(19) United States
(12) Patent Application Publication
(10) Pub. No.: US 2017/0115693 A1
(43) Pub. Date: Apr. 27, 2017

(54) Frameless Tablet

(71) Applicants: Yonggui Li, Qingdao (CN); Kun Li, Qingdao (CN)

(72) Inventors: Yonggui Li, Qingdao (CN); Kun Li, Qingdao (CN)

(21) Appl. No.: 15/400,994

(22) Filed: Jan. 7, 2017

Related U.S. Application Data
(63) Continuation-in-part of application No. 14/619,967, filed on Feb. 11, 2015.
Application No. 14/619,967 is a continuation-in-part of application No. PCT/CN2013/084820, filed on Oct. 8, 2013.

(30) Foreign Application Priority Data
Apr. 25, 2013 (CN) 201310146247.X

(51) Int. Cl. G06F 1/16

(52) U.S. Cl. CPC G06F 1/1626

(57) ABSTRACT

In order for a user to be able to hold a narrow frame or even frameless handheld device on its front touch-screen display, configure a full-screen grip area on the front touch-screen display when no human hands are holding and/touching the touch-screen display. The grip area is ready for holding and will be reduced to be much smaller when a human hand holds the handheld device on the grip area of the touch-screen display. When the grip area is not required, reducing the grip area to be a tiny area located at a corner or an edge of the touch-screen display by a predetermined touch operation, for example, a swipe gesture in the grip area. And when the grip area is required again, restore the grip area by a predetermined touch operation, for example, a drag gesture on the tiny grip area at a corner or an edge of the touch-screen display.

### CROSS-REFERENCE TO RELATED APPLICATIONS

This application is a continuation-in-part of, claims the benefit of and priority to, previously filed U.S. patent application Ser. No. 14/619,967 entitled “FRAMELESS TABLET” filed on Feb. 11, 2015, which is a continuation-in-part of PCT patent application Ser. No. PCT/CN2013/084820 of the same title filed on Oct. 8, 2013, which claims the benefit of and priority to previously filed China patent application Ser. No. 201310146247.X of the same title filed on Apr. 25, 2013, all of which are hereby incorporated by reference in their entirety.

### TECHNICAL FIELD

This invention is a frame solution used for a handheld digital device like a tablet computer, etc.

### BACKGROUND ART

Now, the main problem of the frames of a tablet is that the frames are very wide to increase the size and weight of the tablet.

### BRIEF SUMMARY OF THE INVENTION

In order to solve the problem that the frames of a tablet are too wide, this solution narrows the frames of the tablet to become protective borders as narrow as possible by setting a grip support-point, a grip hold-point and an anti-mis-touch shielding area with the tablet. So, the display area of the tablet is larger than that of a common tablet with the same size, or the size and weight of the tablet both are smaller than that of a common tablet with the same display area. And moreover, the tablet has much more freedom of griping, and the grip positions are no longer just restricted to the frames.

The followings to the end of this section is added newly to this continuation-in-part application.

In order for a user to be able to hold a narrow frame or even frameless handheld device on its front touch-screen display, configure a full-screen grip area on the front touch-screen display when no human hands are holding and/touching the touch-screen display. The grip area is ready for holding and will be reduced to be much smaller when a human hand holds the handheld device on the grip area of the touch-screen display. When the grip area is not required, reducing the grip area to be a tiny area located at a corner or an edge of the touch-screen display by a predetermined touch operation, for example, a swipe gesture in the grip area. And when the grip area is required again, restore the grip area by a predetermined touch operation, for example, a drag gesture on the tiny grip area at a corner or an edge of the touch-screen display.

### BRIEF DESCRIPTION OF THE DRAWINGS

FIG. 1 is a view with both grip support-point and grip hold-point released;

FIG. 2-4 are views with both grip support-point and grip hold-point touched;

FIG. 5 is a view with grip support-point touched and grip hold-point released;

FIG. 6 is a view with grip support-point released and grip hold-point touched;

FIG. 7 is a view with grip support-point touched and grip hold-point touched and docking at an edge;

FIG. 8 is a view with grip support-point touched and grip hold-point released and docking at an edge;

FIG. 9 is a view with grip support-point released and grip hold-point touched and docking at an edge;

FIG. 10 is a view with grip support-point absorbing grip hold-point and docking at a corner;

FIG. 11 is 3d view of a large handheld digital device.

This followings to the end of this section is added newly to this continuation-in-part application.

FIG. 12-25 are front views of a tablet computer with a super narrow frame.

FIG. 26 is a front view of a tablet computer with top and bottom frames.

FIG. 27 is a front view of a tablet computer with only a bottom frame.

FIG. 28 is a front view of a frameless tablet computer.

FIG. 29-30 are front views of a tablet computer with a super narrow frame.

FIG. 31 is a front view of a tablet computer with a wide frame.

### DETAILED DESCRIPTION OF THE INVENTION

A grip support-point, a grip hold-point and an anti-mis-touch shielding area being set on the touch screen of a tablet as 1 and 4 in FIG. 1 narrow the frames of the tablet to become protective borders as narrow as possible as 3 in FIG. 1. This not only removes the redundant frames of the tablet, but also provides convenience for a user to grope a comfortable holding position.

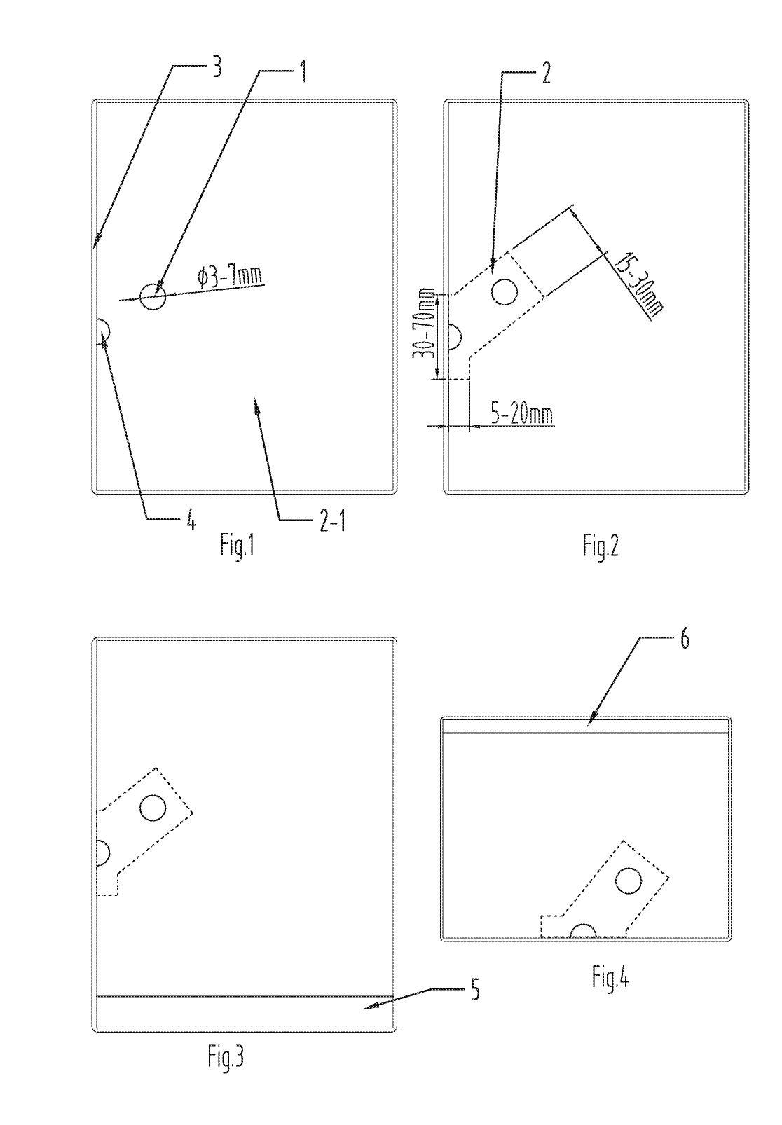

The grip hold-point as 1 in FIG. 1 is a soft shielding point on the touch screen. The point is a round button which had better have an about 3 to 7 mm long diameter. The grip hold-point shields the user interface elements of the touch screen under it and the touch actions on it like slide, one-click, double-click etc. are only used for the other purpose. The grip hold-point can be moved anywhere on the touch screen following the sliding of the finger touching the grip hold-point. The grip hold-point has an automatically tracking function, i.e., when the grip hold-point is in a released status, if a finger touches anywhere in the anti-mis-touch shielding area, the grip hold-point will automatically move into the touch point under the finger. And generally, the grip hold-point is touched and held by the thumb of a hand holding the tablet. The thumb can slide the grip hold-point, or release the grip hold-point first and then touch the touch screen at a proper position in the anti-mis-touch shielding area for the grip hold-point to automatically track the new touch point, or even dangle the thumb to release the grip hold-point, so that the user can change the holding gesture to a comfortable position or clear the touch area to operate or browser. If the user wants to use the thumb holding the tablet to perform common touch operations on the touch screen or to reduce the anti-mis-touch shielding area, the user can use the thumb to touch at a point along the edge of the touch screen, the grip hold-point accordingly docks along the edge as 1-2 in FIG. 7 and the anti-mis-touch shielding area like 2-4 in FIG. 7, 2-5 in FIGS. 8 and 2-6 in FIG. 9 is reduced. Then the grip hold-point only automatically tracks touch points along the edge of the touch screen until it is slid off the edge and the whole of it is inside the touch screen again. If the grip hold-point is slid into a point along the edge of the touch screen, it had better not dock along the edge.

Grip support-point 4 in FIG. 1 is also a soft shielding point on the touch screen and always located at a point of the edges of the touch screen. It is a semicircle or sub-semicircle button shielding the user interface elements of the touch screen under it. And the touch actions on it like slide, one-click, double-click etc. are only used for the other purpose. The grip support-point is equivalent to or a little less than the grip hold-point in size. The graphic elements like color, opacity and hatch etc. can be different between the grip support-point and the grip hold-point. When a finger slides the grip support-point, the grip support-point moves following the movement of the finger. When the finger moving the support-point releases, if the support-point is not in an edge of the touch screen, it automatically docks at the nearest point of the nearest edge of the touch screen. When a finger touches at a point in the anti-mis-touch shielding area along an edge of the touch screen, the support-point automatically moves or tracks into the touch point under the touching finger. And generally, the grip support-point automatically tracks the touch point when the root bulge of the thumb of a hand holding the tablet contacts and presses a border of the tablet and touches the touch screen.

When the grip hold-point and the grip support-point automatically track, the tracking routes can be displayed via animation. When the touch screen goes on and there is not any touch and contact action on the touch screen, the initial positions of the grip support-point and the grip hold-point are as 1 and 4 in FIG. 1. They are about at the middle left and a little upper of the middle left of the tablet. If a user is a lefty, the grip support-point and the grip hold-point are at the middle right and a little upper of the middle right of the tablet.

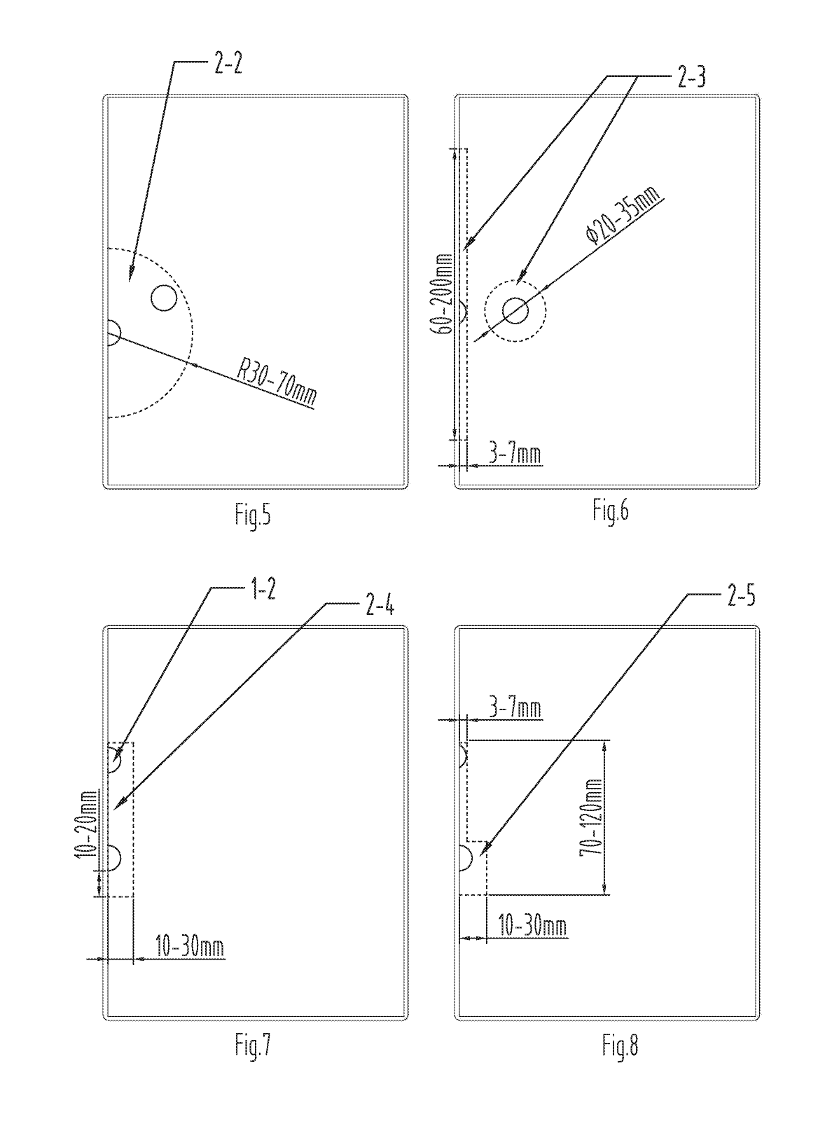

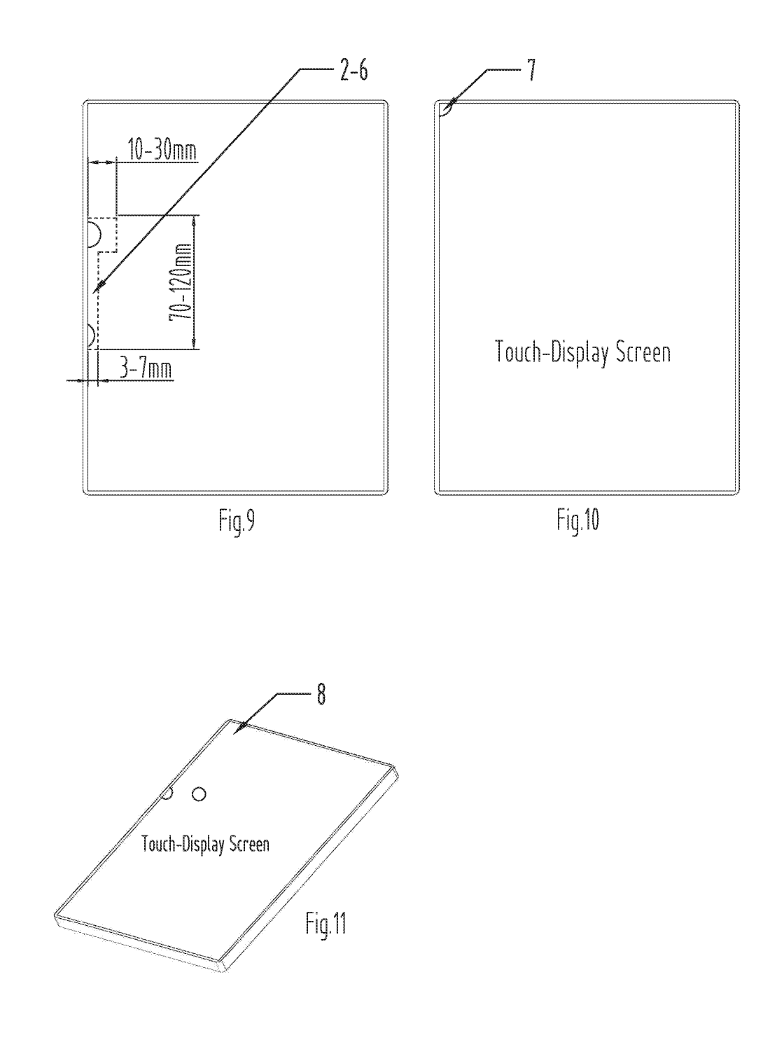

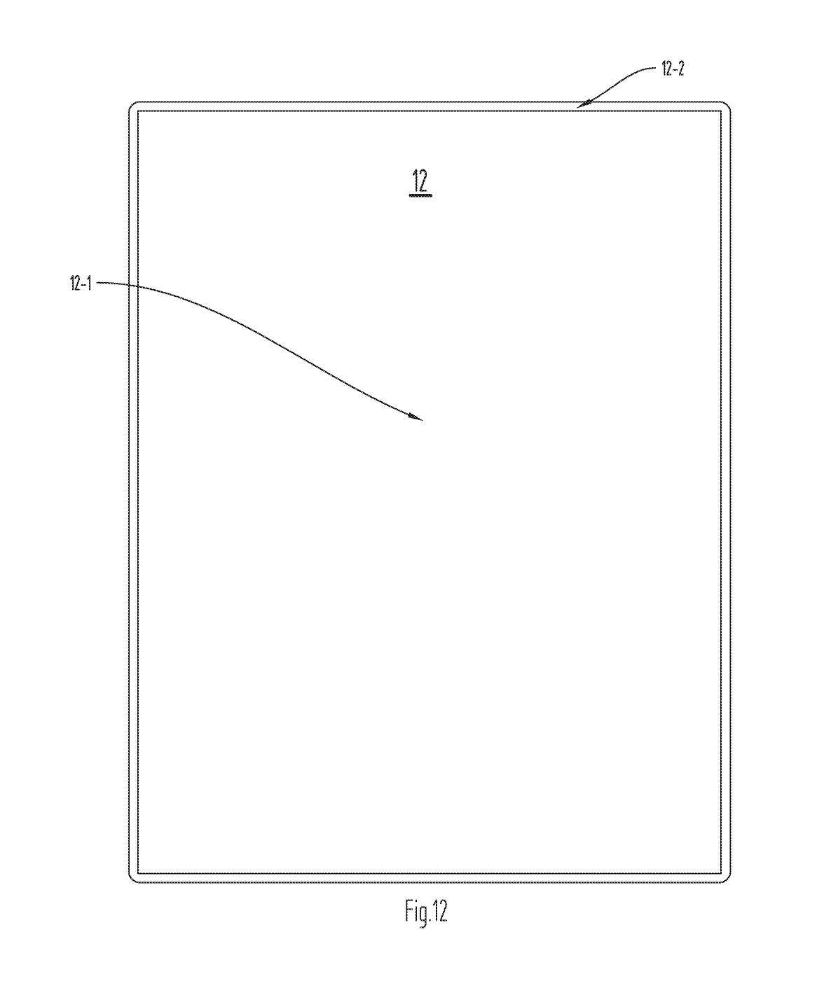

An anti-mis-touch shielding area is configured as 2 in FIG. 2, 2-1 in FIGS. 1 and 2-2 in FIG. 5, 2-3 in FIG. 6, 2-4 in FIG. 7, 2-5 in FIGS. 8 and 2-6 in FIG. 9. The functions of the anti-mis-touch shielding area are A) shielding the user interface elements or common touch actions in the anti-mis-touch shielding area; B) confining the grip support-point and the grip hold-point in the anti-mis-touch shielding area; C) confining the automatically tracking functions of the grip support-point and the grip hold-point in the anti-mis-touch shielding area; D) shielding the extra touch actions produced by the fingerprint, palm print and knuckles etc. of the thumb and the root bulge of the thumb of a hand holding the tablet. The dashed lines of the anti-mis-touch shielding area do not exist actually on the touch screen and are only for illustration.

Different holding gestures have different anti-mis-touch shielding areas. 2 in FIG. 2 is the shape, position and size of the anti-mis-touch shielding area when the tablet is held at a side and the grip support-point and hold-point are both touched effectively and the whole grip hold-point is in the touch screen. This anti-mis-touch shielding area is formed by merging the rectangle able to cover the grip support-point and the grip hold-point and the rectangle able to fully shield the extra touch actions of the root bulge of the thumb of a hand holding the tablet together. The lengthwise midline of the previous rectangle which is a little wider than the thumb is coincident with the connecting line between the centers of the grip support-point and the grip hold-point. The midpoint of a long side of the latter rectangle which is coincident with a sideline of a border of the tablet is the center of the grip support-point. This rectangle is about 0.7 palm long and 0.8 thumb wide. The whole touch screen is the anti-mis-touch shielding area as 2-1 in FIG. 1 when the grip support-point and the grip hold-point are both released. When the grip support-point is touched and the grip hold-point is released, the anti-mis-touch shielding area is a semicircular area centered at the grip support-point with a one-thumb-long radius as 2-2 in FIG. 5. When the grip support-point is released and the grip hold-point is touched, the anti-mis-touch shielding area comprises a circle covering the grip hold-point and a rectangle containing the grip support-point as 2-3. The diameter of the circle is a little larger than the thumb's width. The midpoint of a long side of the rectangle is the pedal from the grip hold-point to the nearest sideline of the touch screen. The length of the rectangle is less than the width of two palm. When the grip support-point and hold-point are both touched and the grip hold-point docks along an edge of the touch screen, the anti-mis-touch shielding area is a rectangle covering the two points as 2-4. This rectangle should be a little longer at the end near the grip support-point. As shown in the figure, a surplus of 10 to 20 mm is given. And the rectangle is about a thumb wide. When the grip support-point is touched and the grip hold-point is released and docks along an edge, the anti-mis-touch shielding area is a combination of two rectangles as 2-5. The wider rectangle covering the grip support-point is about a thumb wide and should be a little longer at the end near the grip support-point. The narrower rectangle is longer than a thumb. When the grip support-point is released and the grip hold-point is touched and docks along an edge, the anti-mis-touch shielding area is a combination of two rectangles as 2-6 in FIG. 9. The wider rectangle covering the grip hold-point is about a thumb wide. The sum of the lengths of the two rectangles is a little longer than the sum of the length of a thumb and the length of the root bulge of the thumb. There are reference dimensions of various anti-mis-touch shielding areas in the drawings.

The released grip support-point or hold-point in the anti-mis-touch shielding area as 2-3, 2-5 and 2-6 can be smaller than a semicircle. In the anti-mis-touch shielding area as 2-4, 2-5 and 2-6, the grip hold-point only automatically tracks the touch point of the finger touching along the edges of the touch screen. Of course, a user can move the grip hold-point to anywhere either along or off the edges by sliding it with the thumb. When the grip hold-point leaves an edge of the touch screen to be inside the touch screen completely and is released, it restores the function to automatically track anywhere in the anti-mis-touch shielding area as 2-1 in FIGS. 1 and 2-2 in FIG. 5. In any cases, after the grip support-point and hold-point are both released for a reasonable delay, the grip support-point, the grip hold-point and the anti-mis-touch shielding area all restore the initial state as 1 in FIG. 1, i.e., the whole touch screen is the anti-mis-touch shielding area. The above-mentioned delay is in order to prevent the grip support-point or/and hold-point from being touched in vain for the time being.

When the tablet does not require to be held by hand, for example, when the tablet will be put up by a support, a user can double-click or one-click on the grip support-point in order that the grip support-point absorbs the grip hold-point and then automatically docks at a default position e.g. 7 in FIG. 10 on the touch screen and the anti-mis-touch shielding area is disabled at the same time. At this time, the grip hold-point disappears and the whole touch screen restores common touch function except at the grip support-point which is one-fourth the size of the original or even smaller right now. When the grip support-point and hold-point need to be enabled again, slide the grip support-point which has absorbed the grip hold-point and is docking at a corner as 7 in FIG. 10 or along a sideline off the corner or the sideline, the grip support-point breaks up into the grip support-point and the grip hold-point again, and then the grip support-point, the grip hold-point and the anti-mis-touch shielding area restore the initial state as 1 in FIG. 1. The grip support-point located at 7 in FIG. 10 can also be moved to the other proper position along the sidelines of the touch screen by a finger. And generally, the grip support-point had better dock at a corner. The system comprising a grip support-point, a grip hold-point and an anti-mis-touch shielding area is an independent one. This system and common touch operations including common multi-touch operations outside the anti-mis-touch shielding area do not interfere with one another.

If a tablet has a task bar or the similar user interface element, in order to avoid mutual interference between the anti-mis-touch shielding area and the task bar, when the tablet is held at a side, the task bar should be put at the bottom as 5 in FIG. 5 or top or the other side of the tablet, but when the tablet is held at the bottom, the task bar should be put at the top as 6 in FIG. 4 or left or right of the tablet.

When the grip support-point or the grip support-point and the grip hold-point both is/are not touched for a long time, the buttons of the grip support-point and hold-point should automatically hide. When there is a screen-touching action, the buttons of the grip support-point and hold-point are enabled and appear again. All of screen-touching actions are shielded before the grip support-point and hold-point are enabled.

The buttons of the grip support-point and hold-point should be light-colored, transparent, small and not prominent as far as possible in order not to influence the beautiful and harmonious user interface of the tablet. Of course, the settings of color depth, transparency, hatch density and hiding delay etc. of the buttons can also be provided for a user to get a better use experience.

Double-click, one-click and three-click on the anti-mis-touch shielding area or the grip support-point having absorbed the grip hold-point are used for acting as HOME, BACK and RECENT buttons or for the other purposes. And sliding the grip hold-point is used for swiping the screen of the tablet or for the other purposes.

The grip support-point, the grip hold-point and the anti-mis-touch shielding area can also be set on the touch screen of a wide frame tablet only for a better holding comfort.

8 in FIG. 11 is a stereo view of the frameless tablet.

The dimensions marked in the drawings and given in this description cannot be regarded as limitations to this invention. Obviously, the other proper and useful dimensions should be treated as part of this invention.

Because the frames are narrowed and the force point of the grip hold-point is right on the touch screen, the design, technics and material strength of the narrow borders and the back supporting structure of the touch screen should be enhanced in order not to weaken the whole structure strength of the tablet from narrowing the frames. Of course, the strength of the touch screen itself should also be enhanced.

The followings are added newly to this continuation-in-part application.

FIGS. 12-25 and 29-30 are front views of a tablet computer comprising a front touch-screen display 12 in FIG. 12 surrounded by a super-narrow frame 12-2. The touch-screen display comprises at least a touch screen and a display, and shows a graphical user interface when the touch-screen display is enabled. The touch screen is a touch-sensitive panel/layer which may be capacitive or resistive and so on. The display is a display screen/layer which is used for displaying the graphical user interface and may be made of LCD, OLED, AMOLED, etc.

A grip area configured on the touch-screen display is used for a human hand, especially a thumb of the hand to hold the tablet, and shields all or a part of the graphical user interface on the touch-screen display, i.e., prevents any unwanted and/or unintended touch of the hand or thumb holding the tablet on the touch-screen display from acting on the graphical user interface, in other words, any detected touch on all or a part of the touch-screen display which is underneath the grip area is either discarded or used for other purposes, for example, minimizing the grip area. If necessary, the grip area may be displayed or rendered by drawing outline, setting opacity and/or using different pattern and/or color than the graphical user interface in order to be identified more easily. But it is recommended that the grip area is configured to be transparent, and furthermore only in rare cases where definitely necessary an outline is used to show the scope of the grip area.

The grip area is equivalent to the anti-mis-touch shielding area of the prior application, wherein the “mis-touch” means any unwanted and/or unintended touch resulting from a human hand holding a touch screen. And moreover the anti-mis-touch shielding area can exist independent of such touch(es). For example, even though there is not any touch on the touch screen, the anti-mis-touch shielding area yet still exists and covers the whole touch screen. And any detected touch on all or a part underneath the anti-mis-touch shielding area of the touch screen is either discarded or used for other purposes, for example, disabling the anti-mis-touch shielding area. In the prior application, shielding common touch actions/operations means shielding graphical user interface elements underneath the anti-mis-touch shielding area.

And a touch-screen display hereby is equivalent to a touch screen comprising at least a touch-sensitive pane/layer and a display screen/layer in the prior application.

As shown in FIG. 12, a grip area 12-1 is configured to cover the whole touch-screen display when detecting no touches on the touch-screen display, i.e., no human hands are holding and/or touching the tablet on the touch-screen display. This configuration is in order to allow a human hand, especially a thumb of the hand to be able to hold the tablet at any location of the touch-screen display in the first instance.

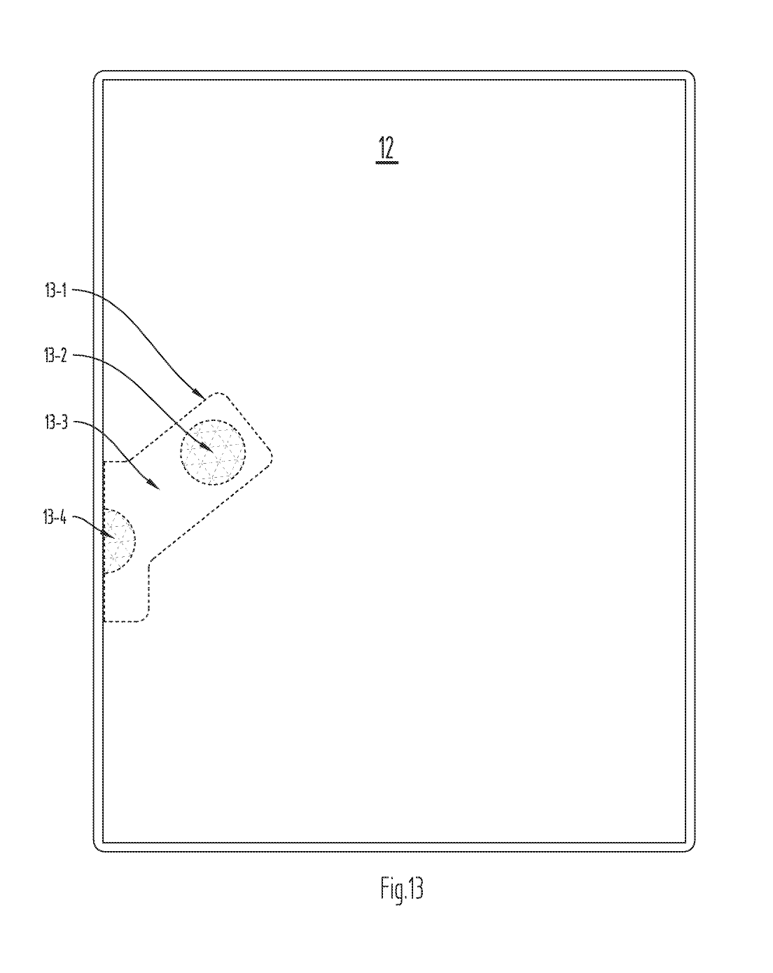

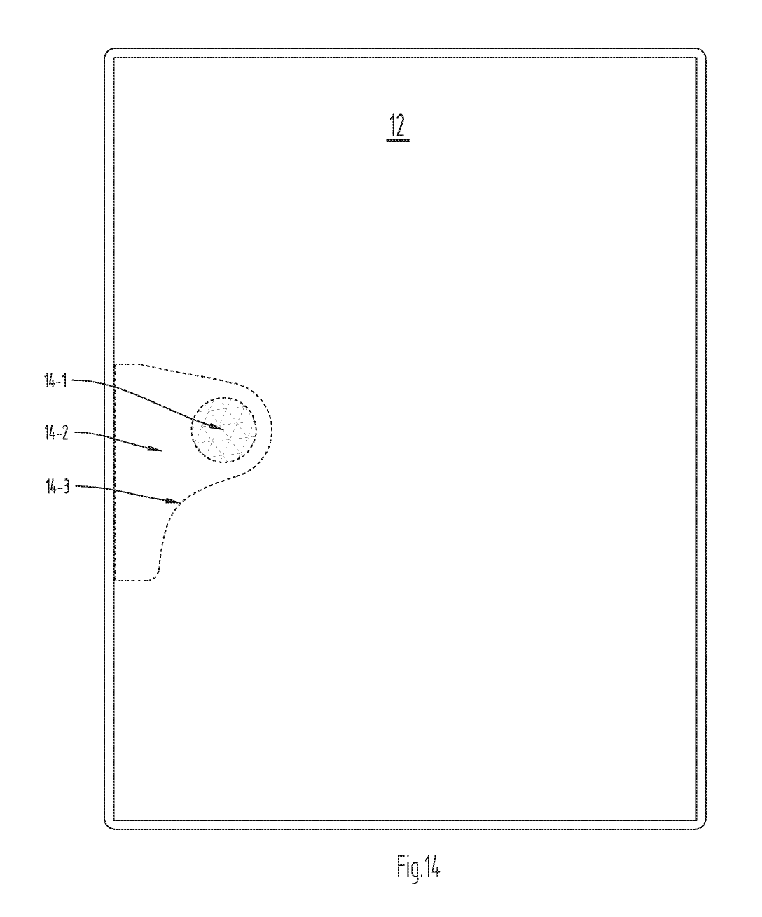

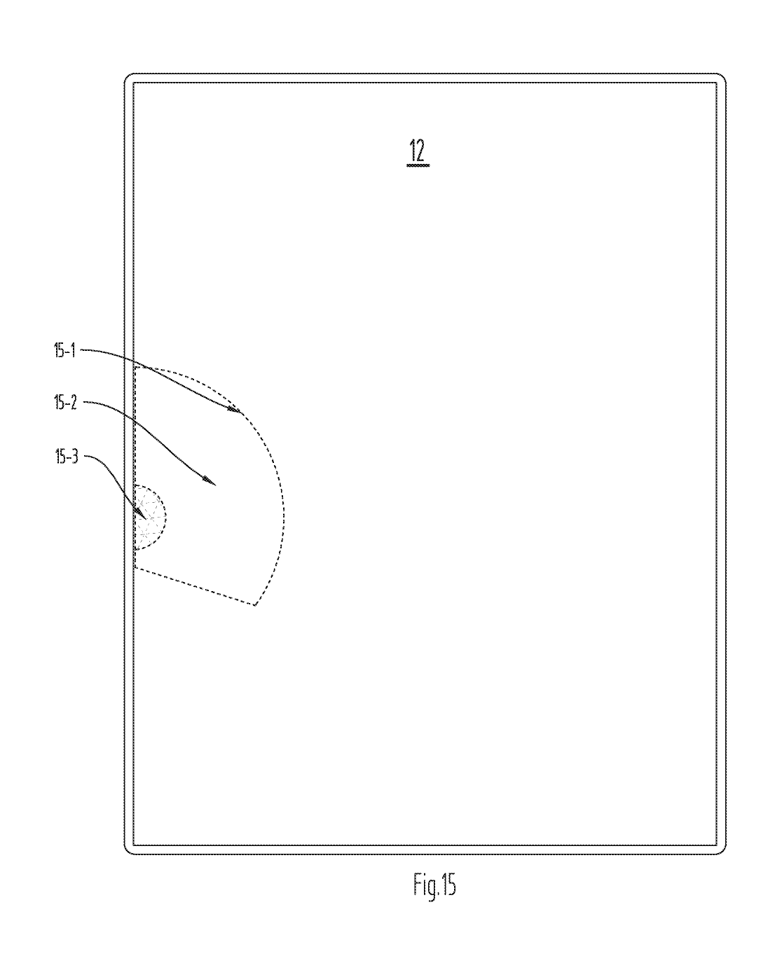

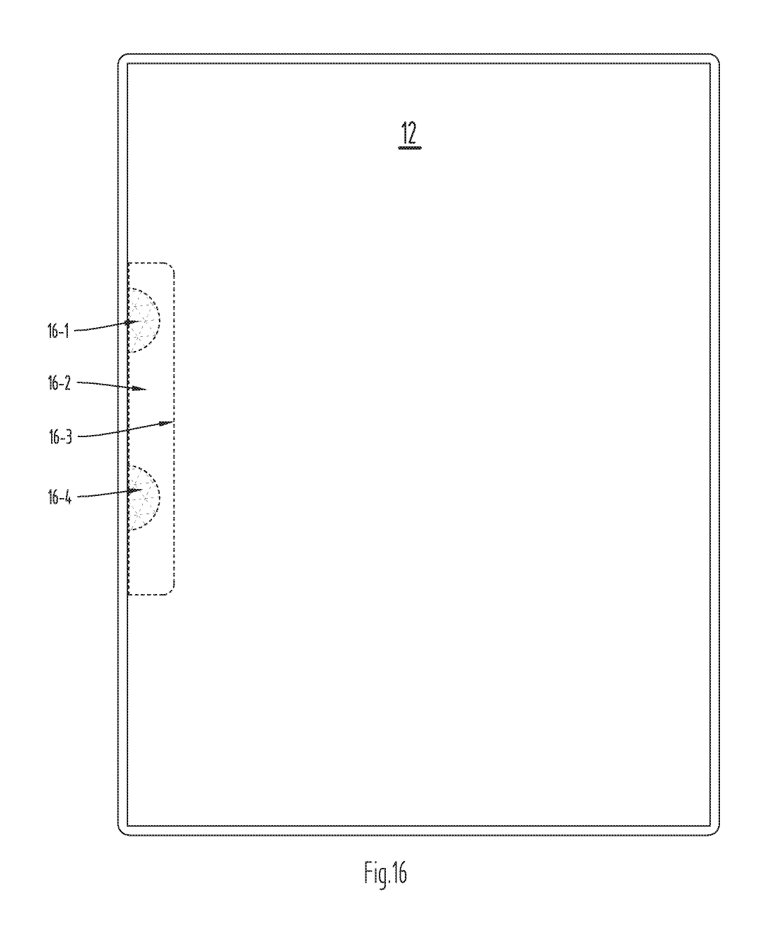

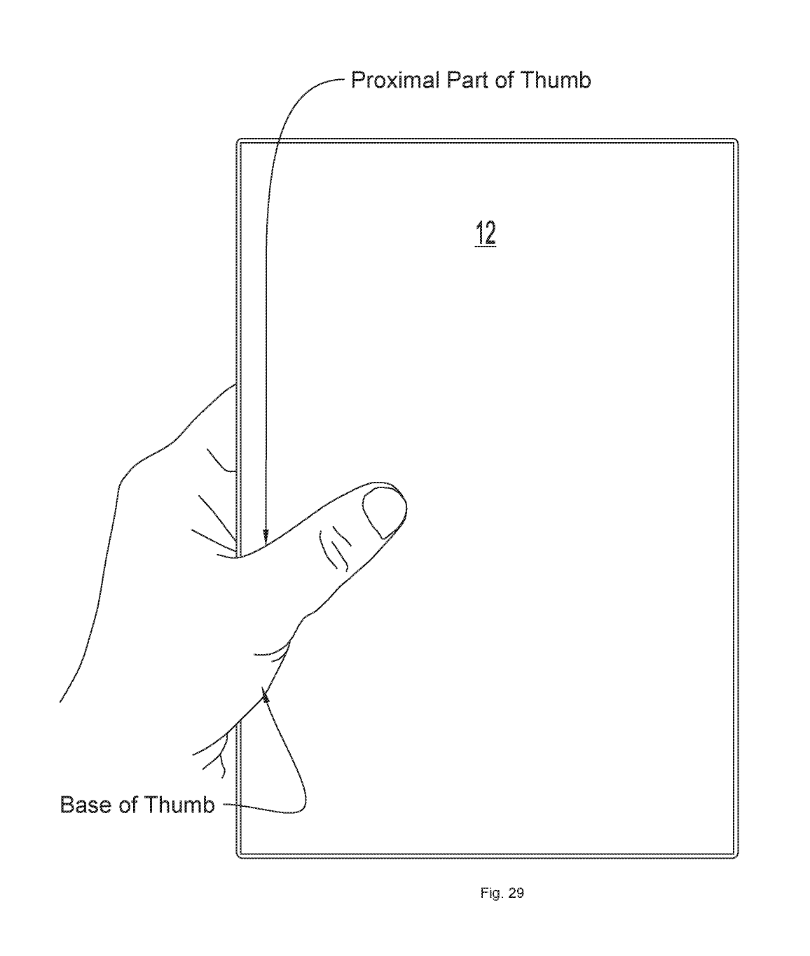

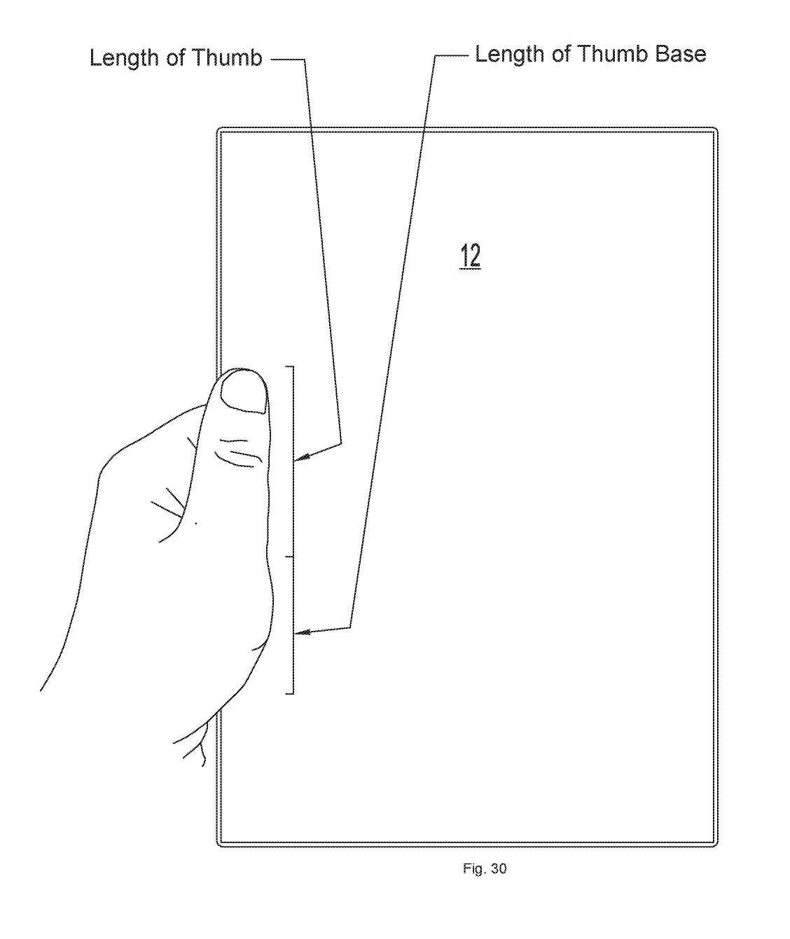

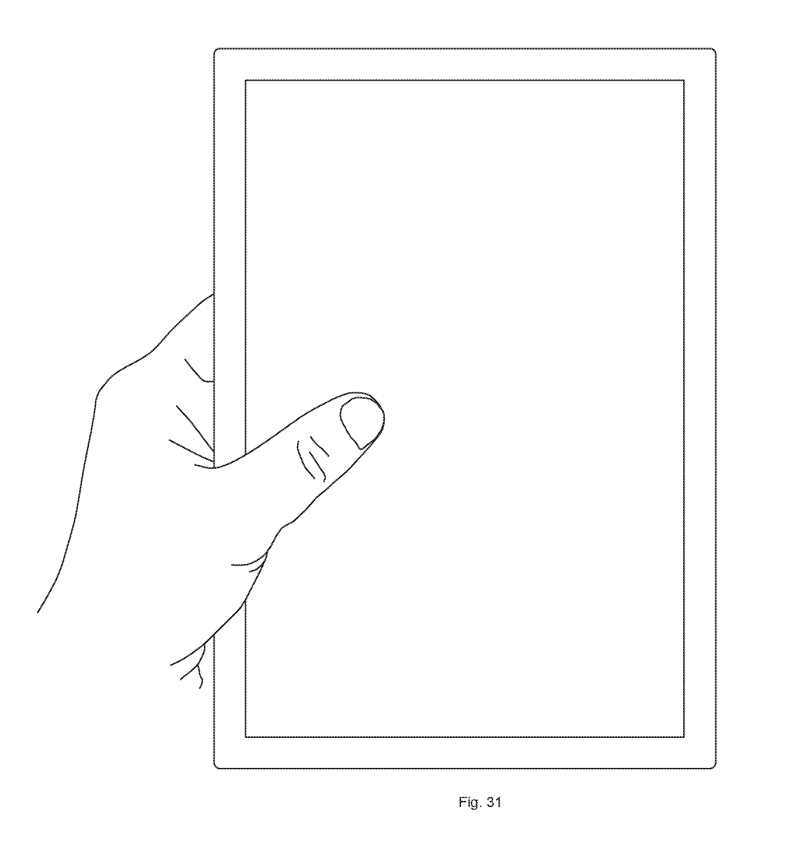

After that, if a human hand holds the tablet with a thumb of the hand on the touch-screen display and the other four fingers on the backside of the tablet as shown in FIG. 29, and both a touch 13-2 in FIG. 13 of the thumb on but away from any edge of the touch-screen display and a touch 13-4 of the thumb base or proximal part (see FIG. 29) on an edge of the touch-screen display are detected, and moreover a distance between the two touches is shorter than the sum of the thumb's length and the thumb base's length (see FIG. 30), the full-screen grip area is reduced and configured to cover a much smaller quasi-boot-shaped area 13-3 on the touch-screen display. One part including the touch 13-2 of the grip area is a little longer and wider than the thumb and another part including the touch 13-4 of the grip area is a little longer than the thumb base's length and a little wider than the thumb's width. The grip area 13-3 should be configured as small as possible but must include all of possible locations where any part of the thumb and its base maybe touches and is touching. An outline 13-1 of the grip area and two hatched patterns of the touches 13-2 and 13-4 are only for illustrative purposes, and had better not be shown or rendered on the touch-screen display.

After that, if the thumb base or proximal part de-touches the edge (This holding situation also looks like FIG. 29), i.e., the touch 13-4 is no longer detected, the grip area changes and is configured to cover a quasi-trapezoidal area 14-2 as shown in FIG. 14. The quasi-trapezoidal area 14-2 has a top length being a little longer than the thumb's width and a bottom length being a little longer than the sum of the thumb's length and the thumb base's length (see FIG. 30) and a height being a little longer than a perpendicular distance from a touch 14-1, i.e. the touch 13-2 in FIG. 13 to the edge. The grip area 14-2 is a little larger than the grip area 13-3 in FIG. 13 and should be configured as small as possible but must include all of possible locations where any part of the thumb and its base maybe touches and is touching. And a hatched pattern of the touch 14-1 is only for illustrative purposes and had better not be shown or rendered on the touch-screen display. As appropriate, an outline 14-3 of the grip area 14-2 may be displayed or rendered on the touch-screen display to show the scope of the grip area 14-2.

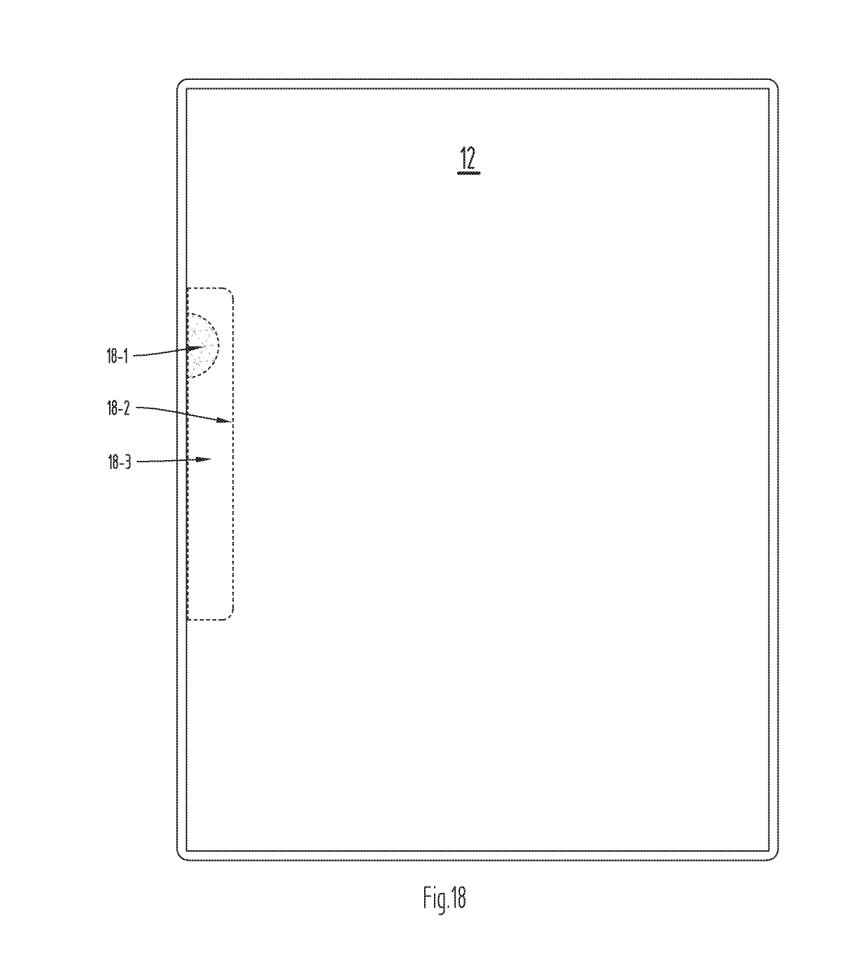

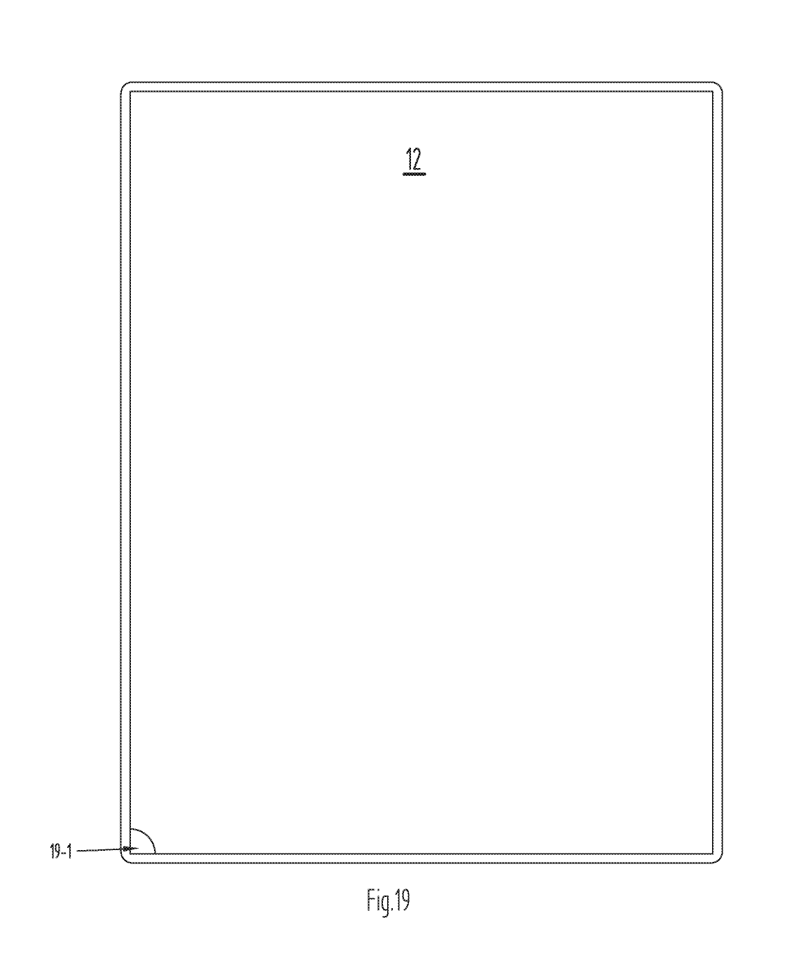

After that, if the thumb slides into the edge (This holding situation looks like FIG. 30), a touch 18-1 as shown in FIG. 18 of the thumb on the touch-screen display is detected on the edge, and the grip area changes again and is configured to cover a rectangular area 18-3 which is a little wider than the thumb's width and a little longer than the sum of the thumb's length and the thumb base's length. The grip area 18-3 should be configured as small as possible but must include all of possible locations where any part of the thumb and its base maybe touches and is touching. And a hatched pattern of the touch 18-1 is only for illustrative purposes, and had better not be shown or rendered on the touch-screen display. As appropriate, an outline 18-2 of the grip area 18-3 may be displayed or rendered on the touch-screen display to show the scope of the grip area 18-3.

After that, if the thumb base or proximal part re-touches both in the grip area 18-3 and on the edge as shown in FIGS. 18 and 30, and a touch 16-4 as shown in FIG. 16 of the thumb base or proximal part is detected on the edge of the touch-screen display, and moreover a distance between the touch and a touch 16-1, i.e., the touch 18-1 in FIG. 18 is shorter than the sum of the thumb's length and the thumb base's length, the grip area is configured to cover a rectangular area 16-2 which is a little wider than the thumb's width and a little longer than the sum of the thumb's length and the thumb base's length. The grip area 16-2 should be configured as small as possible but must include all of possible locations where any part of the thumb and its base maybe touches and is touching. An outline 16-3 of the grip area 16-2 and two hatched patterns of the touch 16-1 and the touch 16-4 are only for illustrative purposes, and had better not be shown or rendered on the touch-screen display.

After that, if the thumb base or proximal part de-touches the edge again (This holding situation yet still looks like FIG. 30), i.e., the touch 16-4 of the thumb base or proximal part is no longer detected, the grip area changes once again and is configured to cover a rectangular area 18-3 in FIG. 18 which is a little wider than the thumb's width and a little longer than the sum of the thumb's length and the thumb base's length. The grip area 18-3 should be configured as small as possible but must include all of possible locations where any part of the thumb and its base maybe touches and is touching. And a hatched pattern of a touch 18-1, i.e., the touch 16-1 in FIG. 16 is only for illustrative purposes and had better not be shown or rendered on the touch-screen display. As appropriate, an outline 18-2 of the grip area 18-3 may be displayed or rendered on the touch-screen display to show the scope of the grip area.

When a human hand holds the tablet with a thumb of the hand on the touch-screen display and the other four fingers on the backside of the tablet as shown in FIG. 29, and both the thumb and the thumb base or proximal part touch the touch-screen display 12 respectively at locations 13-2 and 13-4 as shown in FIG. 13, if the thumb de-touches the touch-screen display, i.e., the touch 13-2 of the thumb is no longer detected, the grip area accordingly changes and is configured to cover a fan-shaped area 15-2 as shown in FIG. 15 which is centered at the centroid of a touch 15-3, i.e. the touch 13-4 in FIG. 13 and has a radius being a little longer than the thumb's length. The grip area 15-2 is larger than the grip area 13-3 in FIG. 13 and furthermore should be configured as small as possible but must include all of possible locations where any part of the thumb and its base maybe touches and is touching. And a hatched pattern of the touch 15-3 of the thumb base or proximal part is only for illustrative purposes, and had better not be shown or rendered on the touch-screen display, but an outline 15-1 of the grip area 15-2 had better be displayed or rendered on the touch-screen display to show the scope of the grip area 15-2.

After that, if the thumb re-touches both in the grip area 15-2 and on an edge of the touch-screen display where the touch 15-3 is as shown in FIGS. 15 and 30, and a touch 16-1 as shown in FIG. 16 of the thumb is detected on the edge, and moreover a distance between the touch and a touch 16-4, i.e., the touch 15-3 in FIG. 15 is shorter than the sum of the thumb's length and the thumb base's length, the grip area is configured to cover a rectangular area 16-2 which is a little wider than the thumb's width and a little longer than the sum of the thumb's length and the thumb base's length. The grip area 16-2 should be configured as small as possible but must include all of possible locations where any part of the thumb and its base maybe touches and is touching. An outline 16-3 of the grip area 16-2 and two hatched patterns of the touch 16-1 and the touch 16-4 are only for illustrative purposes, and had better not be shown or rendered on the touch-screen display.

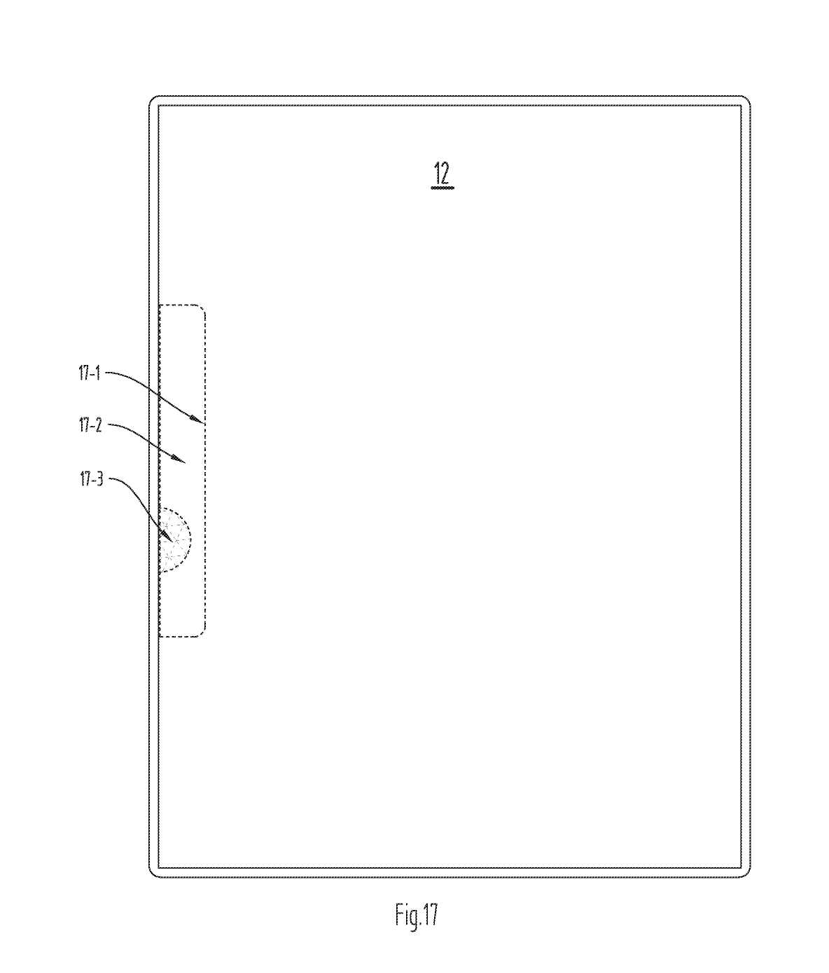

After that, if the thumb de-touches the edge, i.e., the touch 16-1 of the thumb is no longer detected, the grip area changes once again and is configured to cover a rectangular area 17-2 in FIG. 17 which is a little wider than the thumb's width and a little longer than the sum of the thumb's length and the thumb base's length. The grip area 17-2 should be configured as small as possible but must include all of possible locations where any part of the thumb and its base maybe touches and is touching along the edge. And a hatched pattern of a touch 17-3 of the thumb base or proximal part, i.e., the touch 16-4 in FIG. 16 is only for illustrative purposes and had better not be shown or rendered on the touch-screen display. As appropriate, an outline 17-1 of the grip area 17-2 may be displayed or rendered on the touch-screen display to show the scope of the grip area 17-2.

After that, if the thumb re-touches both in the grip area 17-2 and on the edge where the touch 17-3 is as in FIGS. 17 and 30, and a touch 16-1 as shown in FIG. 16 of the thumb is detected on the edge, and moreover a distance between the touch and a touch 16-4, i.e., the touch 17-3 in FIG. 17 is shorter than the sum of the thumb′ length and the thumb base's length, the grip area is configured to cover a rectangular area 16-2 which is a little wider than the thumb's width and a little longer than the sum of the thumb's length and the thumb base's length. The grip area 16-2 should be configured as small as possible but must include all of possible locations where any part of the thumb and its base maybe touches and is touching. An outline 16-3 of the grip area 16-2 and two hatched patterns of the touch 16-1 and the touch 16-4 are only for illustrative purposes, and had better not be shown or rendered on the touch-screen display.

When a human hand holds the tablet with a thumb of the hand on the touch-screen display and the other four fingers on the backside of the tablet as shown in FIG. 29, and both the thumb and the thumb base or proximal part touch the touch-screen display 12 respectively at locations 13-2 and 13-4 as shown in FIG. 13, if the thumb slides into an edge where a touch 13-4 is as shown in FIGS. 13 and 30, a touch 16-1 as shown in FIG. 16 of the thumb is detected on the edge of the touch-screen display, and moreover a distance between the touch and a touch 16-4, i.e., the touch 13-4 in FIG. 13 is shorter than the sum of the thumb's length and the thumb base's length, the grip area is configured to cover a rectangular area 16-2 which is a little wider than the thumb's width and a little longer than the sum of the thumb's length and the thumb base's length. The grip area 16-2 should be configured as small as possible but must include all of possible locations where any part of the thumb and its base maybe touches and is touching. An outline 16-3 of the grip area 16-2 and two hatched patterns of the touch 16-1 and the touch 16-4 are only for illustrative purposes, and had better not be shown or rendered on the touch-screen display.

When no human hands are holding and/or touching the tablet on the touch-screen display and the grip area is configured to cover the whole touch-screen display as shown in FIG. 12, if a human hand holds the tablet with a thumb of the hand on the touch-screen display and the other four fingers on the backside of the tablet as shown in FIG. 29, and only a touch 14-1 as shown in FIG. 14 of the thumb on but away from any edge of the touch-screen display is detected, the full-screen grip area is reduced and configured to cover an much smaller quasi-trapezoidal area 14-2. The quasi-trapezoidal area 14-2 has a top length being a little longer than the thumb's width and a bottom length being a little longer than the sum of the thumb's length and the thumb base's length and a height being a little longer than a perpendicular distance from the touch 14-1 to an nearest edge of the touch-screen display. The grip area 14-2 should be configured as small as possible but must include all of possible locations where any part of the thumb and its base maybe touches and is touching. And a hatched pattern of the touch 14-1 is only for illustrative purposes, and had better not be shown or rendered on the touch-screen display. As appropriate, an outline 14-3 of the grip area 14-2 may be displayed or rendered on the touch-screen display to show the scope of the grip area 14-2.

After that, if the thumb base or proximal part touches both in the grip area 14-2 and on the edge of the touch-screen display, and a touch 13-4 in FIG. 13 of the thumb base or proximal part is detected on the edge, and moreover a distance between the touch and a touch 13-2, i.e., the touch 14-1 in FIG. 14 of the thumb is shorter than the sum of the thumb's length and the thumb base's length, the grip area is reduced and configured to cover a quasi-boot-shaped area 13-3 on the touch-screen display. One part including the touch 13-2 of the grip area 13-3 is a little longer and wider than the thumb and another part including the touch 13-4 of the grip area 13-3 is a little longer than the thumb base's length and a little wider than the thumb's width. The grip area 13-3 should be configured as small as possible but must include all of possible locations where any part of the thumb and its base maybe touches and is touching. An outline 13-1 of the grip area 13-3 and two hatched patterns of the touches 13-2 and 13-4 are only for illustrative purposes, and had better not be shown or rendered on the touch-screen display.

When no human hands are holding and/or touching the tablet on the touch-screen display and the grip area is configured to cover the whole touch-screen display as shown in FIG. 12, if a human hand holds the tablet with a thumb of the hand on the touch-screen display and the other four fingers on the backside of the tablet, and only a touch 15-3 as shown in FIG. 15 of the thumb base or proximal part on an edge of the touch-screen display is detected, the full-screen grip area is reduced and configured to cover a much smaller fan-shaped area 15-2 as shown in FIG. 15 which is centered at the centroid of the touch 15-3 and has a radius being a little longer than the thumb's length. The grip area 15-2 should be configured as small as possible but must include all of possible locations where any part of the thumb and its base maybe touches and is touching. And a hatched pattern of the touch 15-3 of the thumb base or proximal part is only for illustrative purposes, and had better not be shown or rendered on the touch-screen display, but an outline 15-1 of the grip area 15-2 had better be displayed or rendered on the touch-screen display to show the scope of the grip area 15-2.

After that, if the thumb touches both in the grip area 15-2 and on but away from the edge of the touch-screen display as shown in FIGS. 15 and 29, and a touch 13-2 in FIG. 13 of the thumb are detected, and moreover a distance between the touch and a touch 13-4, i.e., the touch 15-3 in FIG. 15 of the thumb base or proximal part is shorter than the sum of the thumb's length and the thumb base's length, the grip area is reduced and configured to cover a quasi-boot-shaped area 13-3 on the touch-screen display. One part including the touch 13-2 of the grip area 13-3 is a little longer and wider than the thumb, and another part including the touch 13-4 of the grip area 13-3 is a little longer than the thumb base's length and a little wider than the thumb's width. The grip area 13-3 should be configured as small as possible but must include all of possible locations where any part of the thumb and its base maybe touches and is touching. An outline 13-1 of the grip area 13-3 and two hatched patterns of the touches 13-2 and 13-4 are only for illustrative purposes, and had better not be shown or rendered on the touch-screen display.

When no human hands are holding and/or touching the tablet on the touch-screen display and the grip area is configured to cover the whole touch-screen display as shown in FIG. 12, if two or more fingers of a human hand swipe anywhere in the full-screen grip area 12-1 on the touch-screen display and a swipe gesture is detected, the grip area 12-1 is reduced and minimized to become a tiny area located at a default location on the touch-screen display, for example, a corner 19-1 in FIG. 19. The tiny quarter-circular grip area 19-1 should be displayed or rendered by drawing outline, setting opacity and/or using different color and/or pattern than the graphical user interface to be easily identified. The tiny grip area 19-1 can be dragged onto a new location along an edge of the touch-screen display which can be configured to be a new default location of the tiny grip area. After the dragging ends, if the tiny grip area is not at an edge or a corner of the touch-screen display, the tiny grip area is configured to be located at a nearest edge/corner. When the tiny grip area is located on an edge of the touch-screen display, the tiny grip area is configured to cover a tiny semi-circular area.

After the tiny grip area is located at an edge or a corner such as 19-1, the tablet can be placed on a desk or a tablet holder, etc. without being held and touch-operated by a human hand(s) on the touch-screen display outside the tiny grip area such 19-1.

If an inward-drag gesture by one finger of a hand is detected on a tiny grip area such as 19-1, the tiny grip area is expanded and configured to cover the whole touch-screen display again as 12-1 shown in FIG. 12.

Besides a distance between two touches is used to help in determining if the two touches is from the same thumb holding and touching the touch-screen display, a size of a touch can be also used to help in determining if the touch is from a finger touching the touch-screen display or a touch-pen touching the touch-screen display, because a touch from any finger is much larger than one from a touch-pen.

When holding the tablet like FIG. 15, 16 (FIG. 30), 17 or 18 (maybe FIG. 30), the area for viewing or both viewing and operating on the graphical user interface of the touch-screen display becomes larger.

Because of fingerprints and finger joints, sometimes when a human hand holds the tablet with a thumb of the hand in the grip area on the touch-screen display and the other four fingers on the backside of the tablet, more than two touches might be detected. And if a distance between any two of the detected touches is shorter than the sum of the thumb's length and the thumb base's length, the grip area is reduced to cover a much smaller area including all of the touches on the touch-screen display.

One or more touches, their movement and the combination thereof on the front touch-screen display resulting from holding and/or touching the tablet may be also referred to as touch gesture or touch operation.

As shown in FIG. 20, a grip area 20-1 is configured to cover the whole touch-screen display when detecting no touches on the touch-screen display, i.e., no human hands are holding and/or touching the tablet on the touch-screen display. This configuration is in order to allow a human hand, especially a thumb of the hand to be able to hold the tablet at any location of the touch-screen display in the first instance.

A grip indicator A as shown in FIG. 20 within the grip area and a grip indicator B as shown in FIG. 20 both in the grip area and on an edge of the touch-screen display are configured to indicate a current holding status of a thumb holding the tablet on the touch-screen display. The “A” and “B” besides the grip indicators are reference characters.

In the prior application, a grip hold-point and a grip support-point are configured in an anti-mis-touch shielding area on a touch screen of a tablet computer. No matter the grip hold-point or the grip support-point can exist independent of a touch of a human hand holding the tablet on the touch screen. For example, even though there are no touches detected on the touch screen, both the grip hold-point and the grip support-point yet still exist in the full-screen anti-mis-touch shielding area on the touch screen. And the “automatically track” of the grip hold-point or the grip support-point means re-rendering the grip hold-point or the grip support-point at a touch underneath a hand, especially a thumb of the hand holding the tablet on the touch screen. A shielding function of the grip hold-point or the grip support-point is from the anti-mis-touch shielding area in which they are included.

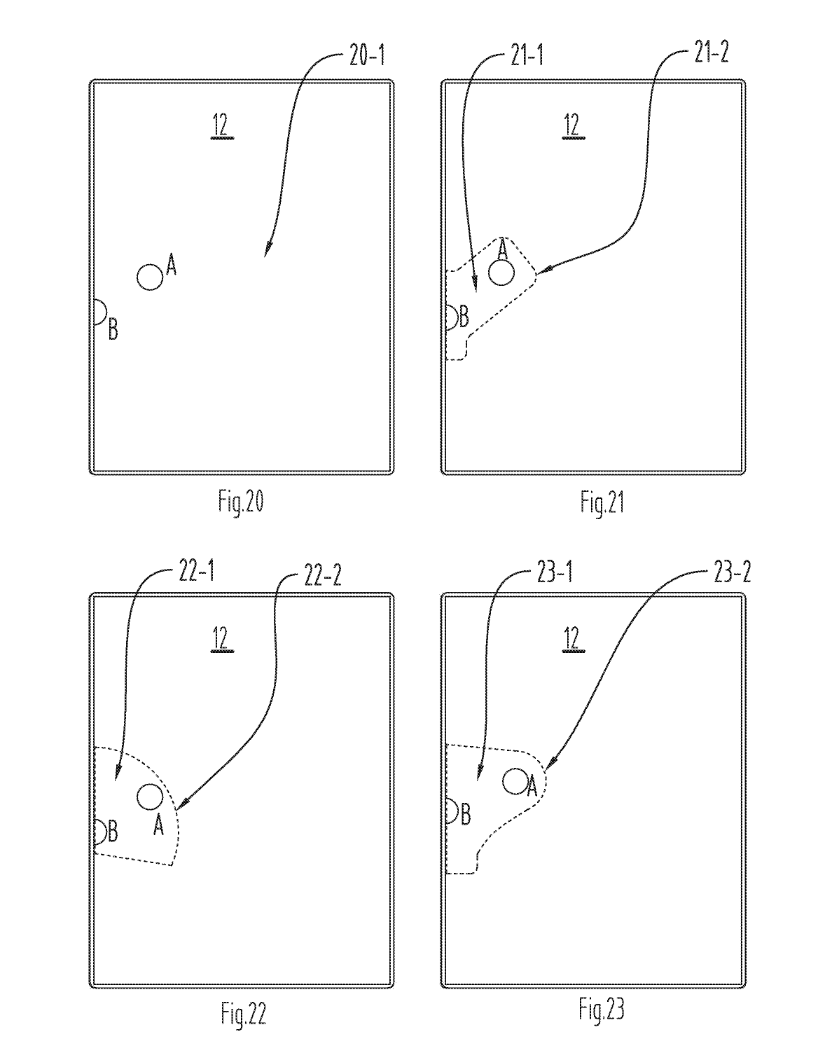

As shown in FIG. 21, if a human hand holds the tablet with a thumb of the hand on the touch-screen display and the other four fingers on the backside of the tablet as shown in FIG. 29, and both a touch of the thumb on but away from any edge of the touch-screen display and a touch of the thumb base or proximal part on an edge of the touch-screen display are detected, and moreover a distance between the two touches is shorter than the sum of the thumb's length and the thumb base's length, the full-screen grip area is reduced and configured to cover a much smaller quasi-boot-shaped area 21-1 on the touch-screen display. The grip indicator A is re-rendered at the touch underneath the thumb and the grip indicator B is re-rendered at the touch underneath the thumb base or proximal part. One part including the grip indicator A of the grip area 21-1 is a little longer and wider than the thumb and another part including the grip indicator B of the grip area 21-1 is a little longer than the thumb base's length and a little wider than the thumb′ width. The grip area 21-1 should be configured as small as possible but must include all of possible locations where any part of the thumb and its base maybe touches and is touching. An outline 21-2 of the grip area is only for illustrative purposes, and had better not be shown or rendered on the touch-screen display.

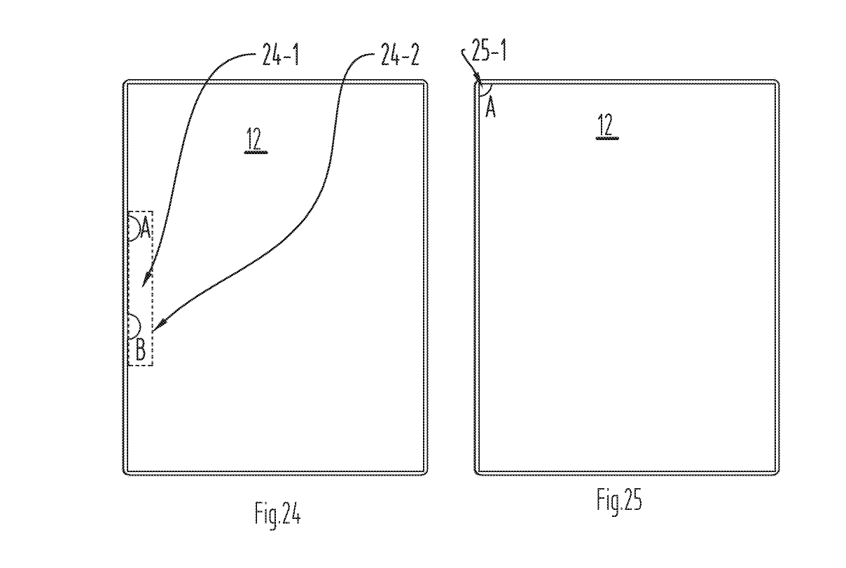

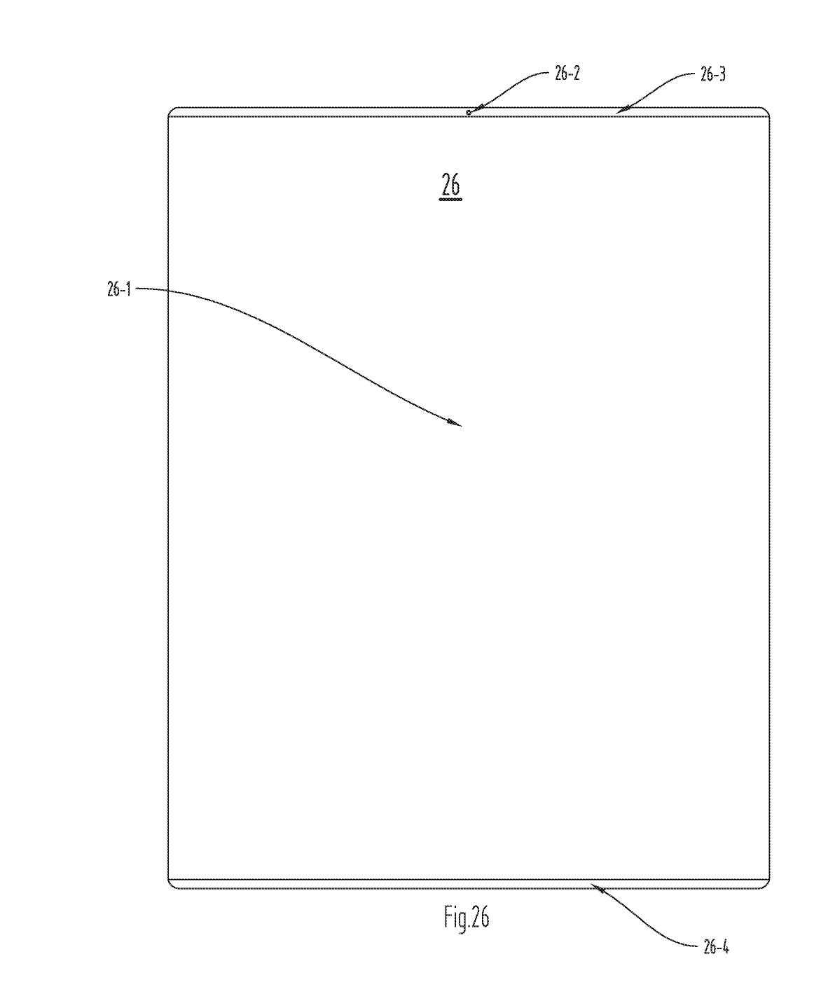

After that, if the thumb base or proximal part de-touches the edge (This holding situation maybe looks like FIG. 29), i.e., the touch of the thumb base or proximal part is no longer detected, the grip area accordingly changes and is configured to cover an quasi-trapezoidal area 23-1 as shown in FIG. 23. The quasi-trapezoidal area has a top length being a little longer than the thumb's width and a bottom length being a little longer than the sum of the thumb's length and the thumb base's length and a height being a little longer than a perpendicular distance from the touch of the thumb i.e. the grip indicator A in FIG. 23 to the edge. The grip area 23-1 is a little larger than the grip area 21-1 in FIG. 21, and furthermore should be configured as small as possible but must include all of possible locations where any part of the thumb and its base maybe touches and is touching. As appropriate, an outline 23-2 of the grip area may be displayed or rendered on the touch-screen display to show the scope of the grip area.

After that, if the thumb slides into the edge (This holding situation maybe looks like FIG. 30), a touch of the thumb on the touch-screen display is detected on the edge, and the grip area changes again and is configured to cover a rectangular area 24-1 in FIG. 24 which is a little wider than the thumb's width and a little longer than the sum of the thumb's length and the thumb base's length. The grip area 24-1 should be configured as small as possible but must include all of possible locations where any part of the thumb and its base maybe touches and is touching. And the grip indicator A is re-rendered at the touch underneath the thumb. As appropriate, an outline 24-2 of the grip area may be displayed or rendered on the touch-screen display to show the scope of the grip area.

After that, if the thumb base or proximal part re-touches both in the grip area 24-1 and on the edge as shown in FIGS. 24 and 30, and a touch of the thumb base or proximal part is detected on the edge of the touch-screen display, and moreover a distance between the touch and the touch underneath the thumb, i.e. the grip indicator A in FIG. 24 is shorter than the sum of the thumb's length and the thumb base's length, the grip area remains unchanged. The grip indicator B is re-rendered at the touch underneath the thumb base or proximal part. An outline 24-2 of the grip area is only for illustrative purposes, and had better not be shown or rendered on the touch-screen display.

After that, if the thumb base or proximal part de-touches the edge again (This situation maybe looks like FIG. 30), i.e., the touch of the thumb base or proximal part is no longer detected, the grip area remains unchanged. As appropriate, an outline 24-2 of the grip area may be displayed or rendered on the touch-screen display to show the scope of the grip area.

When a human hand holds the tablet with a thumb of the hand on the touch-screen display and the other four fingers on the backside of the tablet as shown in FIG. 29, and both the thumb and the thumb base or proximal part touch the touch-screen display respectively at the grip indicator A and the grip indicator B as shown in FIG. 21, if the thumb de-touches the touch-screen display, i.e., a touch of the thumb is no longer detected, the grip area accordingly changes and is configured to cover a fan-shaped area 22-1 as shown in FIG. 22 which is centered at the centroid of a touch underneath the thumb base or proximal part, i.e. the grip indicator B, and has a radius being a little longer than the thumb's length. The grip area 22-1 is larger than the grip area 21-1 in FIG. 21 and furthermore should be configured as small as possible but must include all of possible locations where any part of the thumb and its base maybe touches and is touching. An outline 22-2 of the grip area had better be displayed or rendered on the touch-screen display to show the scope of the grip area.

After that, if the thumb re-touches both in the grip area 22-1 and on an edge of the touch-screen display where the touch underneath the thumb base or proximal part i.e. the grip indicator B is as shown in FIGS. 22 and 30, and a touch of the thumb is detected on the edge, and moreover a distance between the touch and the touch underneath the thumb base or proximal part i.e. the grip indicator B in FIG. 22 is shorter than the sum of the thumb's length and the thumb base's length, the grip area is configured to cover a rectangular area 24-1 in FIG. 24 which is a little wider than the thumb's width and a little longer than the sum of the thumb's length and the thumb base's length. The grip area 24-1 should be configured as small as possible but must include all of possible locations where any part of the thumb and its base maybe touches and is touching. The grip indicator A is re-rendered at the touch underneath the thumb. An outline 24-2 of the grip area is only for illustrative purposes, and had better not be shown or rendered on the touch-screen display.

After that, if the thumb de-touches the edge again, i.e., the touch of the thumb is no longer detected, the grip area remains unchanged and should be configured as small as possible but must include all of possible locations where any part of the thumb and its base maybe touches and is touching along the edge. An outline 24-2 of the grip area may be displayed or rendered on the touch-screen display to show the scope of the grip area.

After that, if the thumb re-touches both in the grip area 24-1 and on the edge as shown in FIGS. 24 and 30, and a touch of the thumb is detected on the edge again, and moreover a distance between the touch and the touch underneath the thumb base or proximal part, i.e. the grip indicator B in FIG. 24 is shorter than the sum of the thumb′ length and the thumb base's length, the grip area remains unchanged. The grip indicator A is re-rendered at the touch of the thumb. An outline 24-2 of the grip area is only for illustrative purposes, and had better not be shown or rendered on the touch-screen display.

When a human hand holds the tablet with a thumb of the hand on the touch-screen display and the other four fingers on the backside of the tablet as shown in FIG. 29, and both the thumb and the thumb base or proximal part touch the touch-screen display respectively at the grip indicator A and the grip indicator B as shown in FIG. 21, if the thumb slides into an edge where the grip indicator B is as shown in FIGS. 21 and 30, and a touch of the thumb is detected on the edge of the touch-screen display, and moreover a distance between the touch and a touch underneath the thumb base or proximal part i.e. the grip indicator B is shorter than the sum of the thumb's length and the thumb base's length, the grip area is configured to cover a rectangular area 24-1 in FIG. 24 which is a little wider than the thumb's width and a little longer than the sum of the thumb's length and the thumb base's length. The grip indicator A is re-rendered at the touch of the thumb as shown in FIG. 24. The grip area 24-1 should be configured as small as possible but must include all of possible locations where any part of the thumb and its base maybe touches and is touching. An outline 24-2 of the grip area is only for illustrative purposes, and had better not be shown or rendered on the touch-screen display.

When no human hands are holding and/or touching the tablet on the touch-screen display and the grip area is configured to cover the whole touch-screen display as shown in FIG. 20, if a human hand holds the tablet with a thumb of the hand on the touch-screen display and the other four fingers on the backside of the tablet as shown in FIG. 29, and only a touch of the thumb on but away from any edge of the touch-screen display is detected, the full-screen grip area is reduced and configured to cover an much smaller quasi-trapezoidal area 23-1 as shown in FIG. 23. The quasi-trapezoidal area has a top length being a little longer than the thumb's width and a bottom length being a little longer than the sum of the thumb's length and the thumb base's length and a height being a little longer than a perpendicular distance from the touch to a nearest edge of the touch-screen display. The grip area 23-1 should be configured as small as possible but must include all of possible locations where any part of the thumb and its base maybe touches and is touching. The grip indicator A is re-rendered at the touch underneath the thumb and the grip indicator B is re-rendered both on the nearest edge and in the grip area as shown in FIG. 23. As appropriate, an outline 23-2 of the grip area may be displayed or rendered on the touch-screen display to show the scope of the grip area.

After that, if the thumb base or proximal part touches both in the grip area 23-1 and on the edge of the touch-screen display as shown in FIG. 29, and a touch of the thumb base or proximal part is detected on the edge, and moreover a distance between the touch and the touch at the grip indicator A of the thumb is shorter than the sum of the thumb's length and the thumb base's length, the grip area is reduced to cover a quasi-boot-shaped area 21-1 in FIG. 21 on the touch-screen display. The grip indicator B is re-rendered at the touch underneath the thumb base or proximal part. One part including the grp indicator A of the grip area 21-1 is a little longer and wider than the thumb, and another part including the grip indicator B of the grip area is a little longer than the thumb base's length and a little wider than the thumb's width. The grip area should be configured as small as possible but must include all of possible locations where any part of the thumb and its base maybe touches and is touching. An outline 21-2 of the grip area is only for illustrative purposes, and had better not be shown or rendered on the touch-screen display.

When no human hands are holding and/or touching the tablet on the touch-screen display and the grip area is configured to cover the whole touch-screen display as shown in FIG. 20, if a human hand holds the tablet with a thumb of the hand on the touch-screen display and the other four fingers on the backside of the tablet as shown in FIG. 29, and only a touch of the thumb base or proximal part on an edge of the touch-screen display is detected, the full-screen grip area is reduced and configured to cover a much smaller fan-shaped area 22-1 as shown in FIG. 22 which is centered at the centroid of the touch underneath the thumb base or proximal part and has a radius being a little longer than the thumb's length. The grip area 22-1 should be configured as small as possible but must include all of possible locations where any part of the thumb and its base maybe touches and is touching. The grip indicator A is re-rendered in the grip area and the grip indicator B is re-rendered at the touch underneath the thumb base or proximal part. An outline 22-2 of the grip area had better be displayed or rendered on the touch-screen display to show the scope of the grip area.

After that, if the thumb touches both in the grip area 22-1 and on but away from the edge of the touch-screen display as shown in FIGS. 22 and 29, and a touch of the thumb is detected, and moreover a distance between the touch and the touch underneath the thumb base or proximal part i.e. at the grip indicator B is shorter than the sum of the thumb's length and the thumb base's length, the grip area is reduced and configured to cover a quasi-boot-shaped area 21-1 on the touch-screen display. The grip indicator A is re-rendered at the touch underneath the thumb. One part including the grip indicator A of the grip area 21-1 is a little longer and wider than the thumb, and another part including the grip indicator B of the grip area is a little longer than the thumb base's length and a little wider than the thumb's width. The grip area 21-1 should be configured as small as possible but must include all of possible locations where any part of the thumb and its base maybe touches and is touching. An outline 21-2 of the grip area is only for illustrative purposes, and had better not be shown or rendered on the touch-screen display.

When no human hands are holding and/or touching the tablet on the touch-screen display and the grip area is configured to cover the whole touch-screen display as shown in FIG. 20, if two or more fingers of a human hand swipe anywhere in the full-screen grip area 20-1 on the touch-screen display and a swipe gesture is detected, the grip area 20-1 is reduced and minimized to become a tiny area located at a default location on the touch-screen display, for example, a corner 25-1 in FIG. 25. The grip indicator A is re-rendered in the tiny grip area 25-1 and the grip indicator B is hidden. The tiny quarter-circular grip area 25-1 can be dragged onto a new location along an edge of the touch-screen display which can be configured to be a new default location of the tiny grip area. After the dragging ends, if the tiny grip area is not at an edge or a corner, the tiny grip area is configured to be located at a nearest edge/corner. When the tiny grip area is located on an edge of the touch-screen display, the tiny grip area is configured to cover a tiny semi-circular area. Every time when the location of the tiny grip area changes, the grip indicator A is re-rendered at the new location of the tiny grip area. The grip indicator A takes the same shape and size of the tiny grip area. Alternatively, the grip indicator B but A is rendered in the tiny grip area and meanwhile the grip indicator A is hidden, or both the grip indicator A and B are hidden.

After the tiny grip area is located at a corner such as 25-1 in FIG. 25 or an edge of the touch-screen display, the tablet can be placed on a desk or a tablet holder, etc. without being held and touch-operated by a human hand(s) on the touch-screen display outside the tiny grip area such as 25-1.

After that, if an inward-drag gesture by one finger of a hand is detected in the tiny grip area such as 25-1, the grip area is expanded and configured to cover the whole touch-screen display again as 20-1 shown in FIG. 20. The grip indicator A is re-rendered in the full-screen grip area but away from any edge of the touch-screen display, and the grip indicator B is re-rendered on an edge of the touch-screen display.

Alternatively, only a grip indicator may be also configured in the grip area.

Besides a swipe gesture, any other touch gesture such as a double-tap gesture, etc. by one or more fingers of a hand detected in the grip area, as long as the gesture is not confused with holding gesture, may be also used for minimizing the grip area to be a tiny one and configuring the tiny grip area to be at a default location such as a corner 19-1 of the touch-screen display.

Besides a drag gesture, any other touch gesture such as a single-tap gesture/a double-tap gesture/a long touch gesture detected in the minimized tiny grip area may be also used for restoring the minimized tiny grip area such as 19-1 to the original status.

A touch gesture may be also referred to as a touch operation.

FIG. 26 is a front view of a tablet computer comprising a front touch-screen display 26 surrounded by a top super-narrow frame 26-3 and a bottom super-narrow frame 26-4. The touch-screen display comprises at least a touch screen and a display, and shows a graphical user interface when the touch-screen display is enabled. A camera 26-2 is located in the middle of the top frame.

As shown in FIG. 26, a grip area 26-1 is configured to cover the whole touch-screen display 26 when detecting no touches on the touch-screen display, i.e., no human hands are holding and/or touching the tablet on the touch-screen display. This configuration is in order to allow a human hand, especially a thumb of the hand to be able to hold the tablet at any location of the touch-screen display in the first instance.

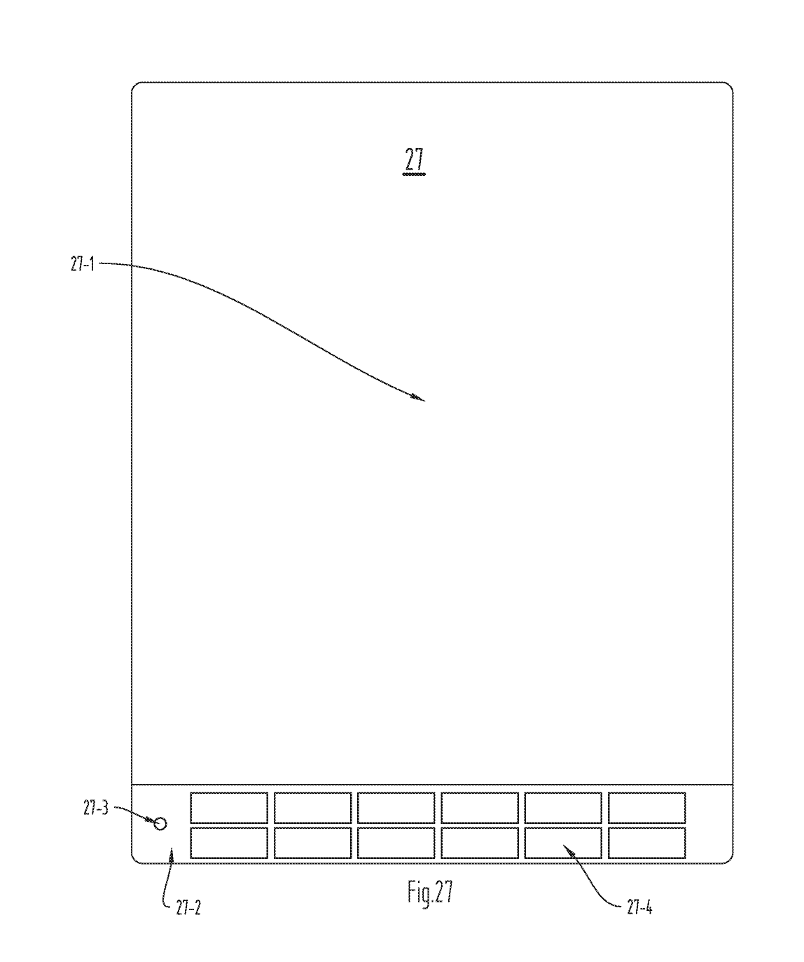

FIG. 27 is a front view of a tablet computer comprising a front touch-screen display 27 and a bottom frame 27-2. The touch-screen display comprises at least a touch screen and a display, and shows a graphical user interface when the touch-screen display is enabled. A camera 27-3 is located at the left of the bottom frame and a 2*6 physical keyboard 27-4 is located on the bottom frame.

As shown in FIG. 27, a grip area 27-1 is configured to cover the whole touch-screen display 27 when detecting no touches on the touch-screen display, i.e., no human hands are holding and/or touching the tablet on the touch-screen display. This configuration is in order to allow a human hand, especially a thumb of the hand to be able to hold the tablet at any location of the touch-screen display in the first instance.

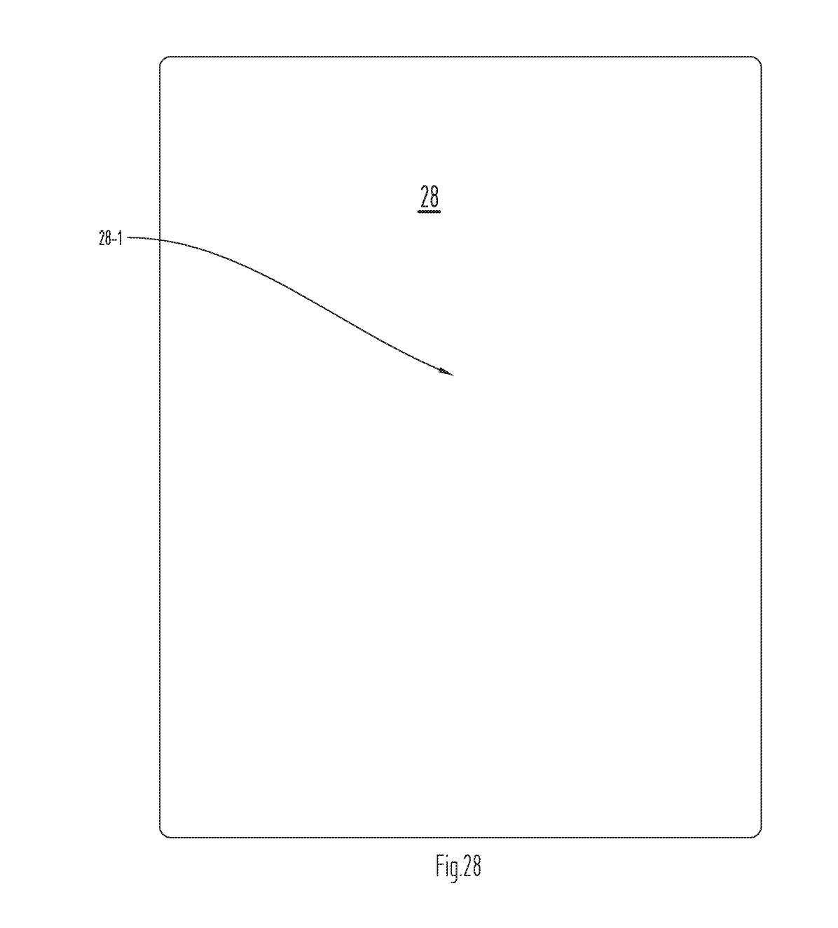

FIG. 28 is a front view of a frameless tablet computer comprising a front touch-screen display 28. The touch-screen display comprises at least a touch screen and a display, and shows a graphical user interface when the touch-screen display is enabled.

As shown in FIG. 28, a grip area 28-1 is configured to cover the whole touch-screen display 28 when detecting no touches on the touch-screen display, i.e., no human hands are holding and/or touching the tablet on the touch-screen display. This configuration is in order to allow a human hand, especially a thumb of the hand to be able to hold the tablet at any location of the touch-screen display in the first instance.

FIG. 29 is a front view of a tablet computer as shown in FIGS. 1-25 which is held by a left human hand on the front touch-screen display.

FIG. 30 is a front view of a tablet computer as shown in FIGS. 1-25 which is held by a left human hand at an edge of the front touch-screen display.

FIG. 31 is a front view of a tablet computer with a wide frame which is held by a left human hand. And a grip area is configured to cover the whole touch-screen display when detecting no touches on the touch-screen display, i.e., no human hands are holding and/or touching the tablet on the touch-screen display.

The present invention is applicable to any kind of frameless or narrow frame tablet computer such as shown in FIGS. 1-30. The present invention is also applicable to any kind of wide frame tablet computer such as shown in FIG. 31. And moreover the present invention is applicable to any kind of handheld device with a front touch-screen display too.

1. A method for configuring a grip area on a touch-screen display of a handheld device, comprising:
detecting no touches on the whole touch-screen display;
configuring the grip area to cover the whole touch-screen display.

2. The method of claim 1, further comprising:
detecting only a touch on but away from any edge of the touch-screen display covered by the full-screen grip area;
reducing the grip area to cover a smaller area including the touch of the touch-screen display.

3. The method of claim 1, further comprising:
detecting only a touch on an edge of the touch-screen display covered by the full-screen grip area;
reducing the grip area to cover a smaller area including the touch of the touch-screen display.

4. The method of claim 1, further comprising:
detecting only two touches respectively on but away from any edge of and on an edge of the touch-screen display covered by the full-screen grip area simultaneously;
reducing the grip area to cover a smaller area including the two touches of the touch-screen display.

5. The method of claim 1, further comprising:
detecting one or more touches simultaneously on the touch-screen display covered by the full-screen grip area;
reducing the grip area to cover a smaller area including all of the touches of the touch-screen display.

6. The method of claim 1, further comprising:
configuring the grip area to be transparent.

7. The method of claim 1, further comprising:
configuring the grip area to be visible as required.

8. The method of claim 1, further comprising:
detecting a predetermined touch operation on the touch-screen display covered by the full-screen grip area;
minimizing the grip area to be a much smaller area.

9. The method of claim 8, further comprising:
configuring the minimized grip area to be at a corner or an edge of the touch-screen display.

10. The method of claim 8, further comprising:
detecting a predetermined touch operation applied on the minimized grip area on the touch-screen display;
restoring the grip area to cover the whole touch-screen display again.

11. The method of claim 1, further comprising:
configuring one or more grip indicators in the grip area on the touch-screen display.

12. The method of claim 11, further comprising:
detecting one or more touches simultaneously on the touch-screen display covered by the full-screen grip area;
reducing the grip area to cover a smaller area including all of the touches of the touch-screen display;
re-rendering at least one of the grip indicators in the reduced grip area on the touch-screen display, wherein at least one of the grip indicators is re-rendered at one of the detected touches.

13. A method for resizing a grip area configured on a touch-screen display of a handheld device, comprising:
detecting one or more touches simultaneously in the grip area on the touch-screen display;
reducing the grip area to cover a smaller area of the touch-screen display.

14. The method of claim 13, further comprising:
configuring the grip area to be transparent.

15. The method of claim 13, further comprising:
configuring the grip area to be visible as required.

16. The method of claim 13, further comprising:
configuring the reduced grip area to be at a corner or an edge of the touch-screen display.

17. A method for resizing a grip area configured on a touch-screen display of a handheld device, comprising:
detecting a predetermined touch operation in the grip area on the touch-screen display;
reducing the grip area to cover a smaller area of the touch-screen display.

18. The method of claim 17, further comprising:
configuring the grip area to be transparent.

19. The method of claim 17, further comprising:
configuring the grip area to be visible as required.

20. The method of claim 17, further comprising:
configuring the reduced grip area to be at a corner or an edge of the touch-screen display.
